(19) United States
(12) Patent Application Publication
(10) Pub. No.: US 2011/0103571 A1
(43) Pub. Date: May 5, 2011

(54) Local Area Network System Comprising at Least One Telephone Terminal and Multimedia Terminals

(76) Inventors: Fabien Astic, Nanterre (FR); Pascal Le Guyadec, Paris (FR); Patrice Mignot, Paris (FR)

(21) Appl. No.: 11/884,559

(22) PCT Filed: Feb. 15, 2006
(86) PCT No.: PCT/EP2006/050972

§ 371 Date: Apr. 9, 2008

(30) Foreign Application Priority Data
Feb. 18, 2005 (FR) 05/50462

(51) Int. Cl. H04M 7/00

(52) U.S. Cl. 379/220.01

(57) ABSTRACT

The invention relates to a routing device intended to equip a local network in which at least one telephone terminal is associated with multimedia terminals. The device is intended to automatically select at least one multimedia terminal that has to receive or send a stream at the same time as a telephone communication is established. It comprises:
means for detecting the location of the terminals, their state of use, and their capabilities, and
means for automatically selecting the multimedia terminal that has to receive or send a stream depending on its location, and/or its capabilities and/or its availability.

The invention relates to a local network system, in particular a domestic network, comprising at least one telephone terminal and multimedia terminals capable of receiving and/or sending data at the same time as a telephone conversation.

The most commonplace telephone terminals, in particular fixed-telephony terminals, are designed almost exclusively for telephone conversations, possibly for receiving digital data at low throughput, such as SMS and/or MMS messages. On the other hand, except for videophone terminals, which are not commonly used products, telephone terminals are not capable of sending or receiving video data or computer programs.

However, the requirement is often felt to communicate, at the same time as a telephone conversation, data which are not capable of being processed by a commonplace telephone terminal.

To allow communications of this type, it is known to associate with a telephone terminal one or more multimedia terminals, for example a personal computer, thereby allowing the users to transmit files such as emails, photos, videos, simultaneously with a telephone conversation. It is also possible to perform exchanges of videophone type by associating a telephone terminal, a television receiver, and a video camera.

The invention starts from the finding that the known systems for associating telephone terminals with multimedia-type data senders and/or receivers do not make it possible to satisfy users' requirements in a sufficient manner.

The system according to the invention comprises a routing device comprising:
means for determining for each multimedia terminal of the local network, the following parameters: the identity of the device, the place where it is installed, its capabilities and the state of this device,
means for transferring the data received by the local network to the multimedia terminal closest to the telephone terminal on which the communication is performed and/or to the multimedia terminal having the capabilities best suited to the data received.

The capability of a multimedia terminal is understood to mean the capabilities related to the function that this device has to fulfill. For example, for a computer this involves in particular the characteristics of its microprocessor, the capacity of its random access memory, the capacity of its hard disk and the characteristics of the viewing device such as the screen size and the resolution. The state of each multimedia terminal is understood to mean the off state, the standby state or the on state. Simple connection of the terminal to the routing device suffices to ascertain this state.

With the system according to the invention, if the local network comprises several telephone terminals for one and the same subscriber number, the routing device will automatically select the multimedia terminal closest to the telephone terminal used. The routing device can also select, in particular in an installation comprising only a single telephone terminal, the available multimedia terminal whose characteristics are best suited to the received data stream. For example, if the stream received comprises video data, such as detected by means of analysis of the routing device, the latter may be programmed to automatically route the video data to the multimedia device having the largest screen or the best resolution. In the case where a video camera is available and ready to send messages, the routing device is programmed to automatically choose the screen device closest to the video camera. For this purpose, the camera and the screen device are previously configured as belonging to one and the same geographical place and/or are coupled.

If the user, in the course of a telephone conversation, changes telephone terminal, then the routing device automatically transfers the data to the multimedia device or devices closest to the second telephone terminal.

The routing device is, preferably, embodied in the form of a software means which can be incorporated into a device that is independent of the terminals. As a variant, the routing device is incorporated into a terminal, such as a telephone terminal or into a multimedia terminal.

In one embodiment, for sending data to a user who is not in the local network, the routing device comprises, according to one embodiment, means for directing the stream which cannot be used by the telephone terminal of the talker, to the multimedia device of this talker which is the most appropriate for this talker. It is known that the usual IP telephone protocols, such as STP and H323, are such that in the course of the opening of a communication session, the communication parameters are exchanged and negotiated according to the capabilities of the terminals. The communication parameters are for example the codecs used for the voice and video streams.

The communication protocols between the routing device and the multimedia terminals can be of any nature, standardized or of proprietary types. By way of nonlimiting example of standardized protocols mention may be made of the UpnP, JINI Salutation protocols allowing all the resources offered by the network to be made available to any terminal whatsoever.

In one embodiment, the routing device is connected to the access gateway from the local network to the communication network, and controls this gateway in such a way that the multimedia data streams are transferred directly from the gateway to the selected terminals.

In another embodiment, a central device of the proxy type, that receives the data from the gateway and retransmits them to the multimedia devices in the local network, is envisaged in the local network. In this case, the routing device comprises control means for this central device. This central device is also preferably a software product disposed, for example, in the gateway or in a telephone terminal.

In one embodiment, a control device is envisaged which, after the gateway, directs the data to all the multimedia devices capable of receiving the transmitted data, the routing device selecting that one of the multimedia terminals which has to be used. This arrangement is particularly useful when several media enter into the communication as it proceeds.

This control device intended to select all the multimedia terminals, can be disposed either in the local network, or outside between the outside network and the gateway.

The invention thus relates to a routing device intended to equip a local network in which at least one telephone terminal is associated with multimedia terminals, which is characterized in that being intended to automatically select at least one multimedia terminal that has to receive or send a stream at the same time as a telephone communication is established, it comprises:

means for detecting the location of the terminals, their state of use, and their capabilities, and

means for automatically selecting the multimedia terminal that has to receive or send a stream depending on its location, and/or its capabilities and/or its availability.

In one embodiment, the device comprises means for controlling a central control member so that the latter sends to the, or receives from the, multimedia terminal selected, the stream not passing through the telephone terminal.

According to one embodiment, the routing to the selected terminal is performed by a gateway connecting the local network to a communication network, and the device comprises means for controlling the gateway so that the latter sends to the selected terminal, or receives from the latter, the stream to be routed.

In one embodiment, a control device directs the incoming streams entering the local network to all the terminals of the local network, and the routing device comprises means for preventing the incoming streams from being used by the unselected terminals.

According to one embodiment, the device is incorporated into a device included in the group comprising the terminals and the gateway connecting the communication network to the local network.

In one embodiment, the device comprises programming means so that the user can establish criteria for automatic selection of the multimedia terminals.

The invention also relates to a method of managing a local network in which at least one telephone terminal is associated with multimedia terminals, characterized in that at least one multimedia terminal is selected automatically, said terminal having to receive or send a stream at the same time as a telephone communication is established, this automatic selection being performed on the basis of the location of the terminals, their state of use and/or their capability.

In one embodiment in which the local network comprises at least two telephone terminals, the multimedia terminal suited to the stream concerned which is closest to the telephone terminal used is selected automatically.

In one embodiment, the multimedia terminal selected automatically is the one which exhibits the best performance, depending on its capabilities, for utilizing the stream to be received or sent at the same time as the telephone communication.

According to one embodiment, for which the local network comprises a central control member, or a gateway connecting this local network to a communication network, this central control member, or the gateway, is controlled so that the streams received are directed to the selected terminal or terminals.

In one embodiment, all the incoming streams entering the local network are directed to all the terminals of this network, and after automatic selection, the unselected terminals are prevented from using the incoming streams.

The criteria for automatic selection of the multimedia terminals are for example programmable.

Other characteristics and advantages of the invention will appear with the description of some of its embodiments, said description being given while referring to the appended figures in which:

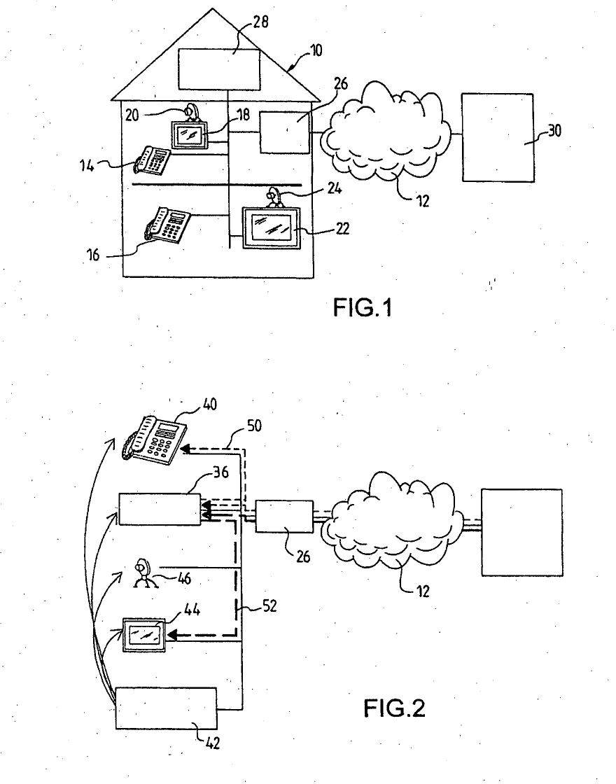

FIG. 1 represents a system in accordance with the invention, and

FIGS. 2 to 4 represent three embodiments of the invention.

Represented in FIG. 1 is a local network such as a domestic network 10 connected to a communication network, for example the Internet network 12.

In the example represented the local network comprises two telephone terminals, namely a telephone terminal 14 disposed in a bedroom, and a telephone terminal disposed in another room such as a lounge. In proximity to the terminal 14 is a computer 18 and a video camera 20.

In proximity to the telephone terminal 16 is, on the one hand, a television receiver 22, and on the other hand, another video camera 24.

The link from the local network to the communication network 12 is effected, in a conventional manner, by a gateway 26.

According to the invention, the network 10 comprises, furthermore, a routing device 28 linked to all the terminals of the local network, including to the gateway 26, for controlling the routing of the stream received from the gateway 26 to the multimedia terminal most appropriate to the stream received and which cannot be processed by the telephone terminal.

The routing device 28 comprises a means for recording the identity and the location of each of the devices of the network, including the telephone terminals. This routing device also comprises means for receiving from each of the terminals of the local network, its characteristics, its capabilities and its availability. It also comprises means for analyzing the streams received.

In the course of a communication session, the device 28, after analysis of the stream received, routes this stream in an automatic manner to the most appropriate multimedia terminal. The most appropriate terminal is determined on the basis of the analysis and the characteristics of the devices and their availability.

Thus in the example represented, a stream received from a multimedia terminal 32 connected to the network 12 is also associated with a telephone terminal (not shown) and directed, by virtue of the device 28, to the computer 18 if it is the telephone terminal 14 which is in conversation, or to the television 22 if it is the telephone terminal 16 which is used for the telephone conversation.

In the case of a communication of the video conference type, the camera 24 is used if the television 22 has been selected and, in the converse case, it is the camera 20 which is used when it is the computer 18 which has been selected.

If, during the telephone communication, certain parameters are modified, for example if the user transfers his communication from the terminal 14 to the terminal 16, then, automatically, the routing device 28 selects the multimedia device or terminal closest to the telephone terminal.

In the example, the device 28 can be programmed by the user in such a way that the latter can impose criteria such as, for example, for certain types of stream, exclusively choose one of the multimedia terminals.

In one embodiment, several routing devices are envisaged.

The example represented in FIG. 2 relates to one embodiment which adapts to a communication session of one type, that is to say a single telephone call managing the audio, video and data streams.

In this example, the local network comprises a central control device 36 traversed by all the streams originating from the gateway 26 and intended for the latter gateway. This device 36 is, for example, integrated with the gateway 26 or integrated with a telephone terminal 40.

Thus, this device 36 is traversed by all the incoming and outgoing streams. In this case, the routing device 42, which is connected to all the terminals of the local network, that is to say to the telephone terminal 40 as well as to the multimedia terminals 44 (display device) and 46 (video camera), is also linked to the control device 36. The routing device 42 controls the central device 36 so that it routes the streams to the appropriate devices.

The protocols used between the device 36 and the terminals are, for example, the SIP, H323, or UPnP audio/video protocols.

In FIG. 2 the voice streams are represented by a thin dashed line 50, and the video streams by a thicker dashed line 52.

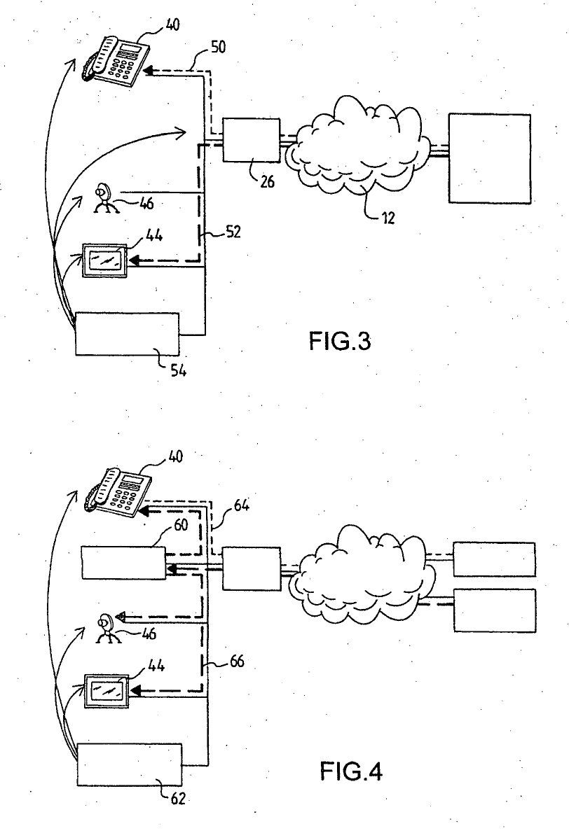

In FIG. 3, the elements which correspond to those of FIG. 2 have been indicated by the same reference numerals.

This embodiment differs from that represented in FIG. 2 by the fact that the routing device 54 controls the gateway 26 directly such that the latter ensures the routing determined by this device 54. Stated otherwise, in this example, no central control device (having the reference 36 in the embodiment of FIG. 2) is envisaged.

When a new multimedia terminal intervenes in the course of a telephone communication, the device 54 controls a new route to the gateway 26 for trunking the new stream to the selected multimedia terminal. This new route is determined on the basis of the negotiation performed, in a known manner, during the communication session between IP terminals, this session constituting the preliminary to the establishment of an IP communication between terminals.

In the example represented in FIG. 4, a session control device 60 is envisaged for allowing a multiplicity of communication sessions.

In this example, the device 60 addresses the calls to all the terminals 40, 44, 46 and the routing device 62 is programmed to select the terminals which will be used in the call and to disable the unselected terminals, that is to say to prevent these unselected terminals from using the incoming streams.

In FIG. 4, the thin dashed line 64 represents a voice communication which has been established while the thick dashed line 66 represents video communication calls.

In this example, the device 60 is disposed either in the local network or outside.

1. A routing device intended to equip a local network in which at least one telephone terminal is associated with multimedia terminals wherein being intended to automatically select at least one multimedia terminal that has to receive or send a data stream at the same time as a telephone communication is established by one of the phone terminals, it comprises:
means for detecting the location of the terminals, their state of use, and their capabilities, and
means for automatically selecting the most adapted multimedia terminal that has to receive or send a data stream depending on its location, and/or its capabilities and/or its availability.

2. The device as claimed in claim 1, wherein it comprises means for controlling a central control member so that the latter sends to the, or receives from the, multimedia terminal selected, the stream not passing through the telephone terminal.

3. The device as claimed in claim 1, wherein the routing to the selected terminal being performed by a gateway connecting the local network to a communication network, it comprises means for controlling the gateway so that the latter sends to the selected terminal, or receives from the latter, the stream to be routed.

4. The device as claimed in claim 1, wherein a control device directing the incoming streams entering the local network to all the terminals of the local network, the routing device comprises means for preventing the incoming streams from being used by the unselected terminals.

5. The device as claimed in claim 1, wherein it is incorporated into a device included in the group comprising the terminals and the gateway connecting the communication network to the local network.

6. The device as claimed in claim 1, wherein it comprises programming means so that the user can establish criteria for automatic selection of the multimedia terminals.

7. A method of managing a local network in which at least one telephone terminal is associated with multimedia terminals, wherein at least one adapted multimedia terminal is selected automatically, said terminal having to receive or send a data stream at the same time as a telephone communication is established by one of the phone terminals, this automatic selection being performed on the basis of the location of the terminals, their state of use and/or their capability.

8. The method as claimed in claim 7, wherein the local network comprising at least two telephone terminals, the multimedia terminal suited to the stream concerned which is the closest to the telephone terminal used is selected automatically.

9. The method as claimed in claim 7, wherein the multimedia terminal selected automatically is the one which exhibits the best performance, depending on its capabilities, for utilizing the stream to be received or sent at the same time as the telephone communication.

10. The method as claimed in claim 7, wherein the local network comprising a central control member, or a gateway connecting this local network to a communication network, this central control member, or the gateway, is controlled so that the streams received are directed to the selected terminal or terminals.

11. The method as claimed in claim 7, wherein all the incoming streams entering the local network are directed to all the terminals of this network, and in that after the automatic selection, the unselected terminals are prevented from using the incoming streams.

12. The method as claimed in claim 7, wherein the criteria for automatic selection of the multimedia terminals are programmable.
